(19) United States
(12) Patent Application Publication
(10) Pub. No.: US 2005/0218702 A1
(43) Pub. Date: Oct. 6, 2005

(54) Sliding roof for a motor vehicle

(75) Inventor: Kai Stehning, Usingen (DE)

Correspondence Address: CARLSON, GASKEY & OLDS, P.C., 400 WEST MAPLE ROAD, SUITE 350, BIRMINGHAM, MI, 48009, US

(73) Assignee: ArvinMeritor GmbH

(21) Appl. No.: 11/083,275

(22) Filed: Mar. 17, 2005

(30) Foreign Application Priority Data
Apr. 2, 2004 (DE) 20 2004 005 268.7

(51) Int. Cl. B60J 7/00

(52) U.S. Cl. 296/216.04

(57) ABSTRACT

A sliding roof for a motor vehicle includes a cover that selectively opens and closes a roof opening. During opening movement of the sliding roof, the cover is shifted over a stationary roof portion. The stationary roof portion includes a guide rail structure that is centrally located on the stationary roof portion as seen in a longitudinal vehicle direction. A rear end of the cover is guided in the guide rail structure at least during the opening movement of the cover. A roof skin is formed as one piece and cooperates with the stationary roof portion to provide a sealed roof skin area at the guide rail structure.

### BACKGROUND OF THE INVENTION

The application claims priority to German Patent Application No. 20 2004 005 268.7, which was filed on Apr. 2, 2004.

The invention relates to a sliding roof for a motor vehicle, comprising a cover and a guide system that selectively opens and closes a roof opening by shifting the cover over a stationary roof portion.

Vehicle roofs of this type are designated as so-called “spoiler” roofs in which the cover can be raised above a vehicle roof and moved over a roof skin in a rearward direction. The cover is moved at least in part over an immobile, stationary roof portion so that the roof opening is exposed to as large an area as possible. In prior art systems, longitudinal guides are provided on the stationary roof portion along lateral sides of the stationary roof portion. These longitudinal guides are visible from outside the motor vehicle and are subject to environmental influences. For this reason, seals are provided on an upper end of the longitudinal guides to prevent the ingress of dirt and moisture. Such seals must meet high demands and therefore are, just like the longitudinal guides, costly to manufacture and assemble.

From DE 102 39 863 A1 there is known a vehicle roof in which a lever is mounted in a region of a rear end of the cover. The lever has one end provided with a first lateral pin that is permanently coupled with a guide rail. A second pin runs into the guide rail in the raised state.

In DE 102 39 863 A1 the stationary roof portion is formed in one piece and is provided with a longitudinal slot according to one embodiment. Underneath this longitudinal slot the guide rail is arranged and is configured as a separate part. Underneath the guide rail, a water management system in the form of a water drain gutter, is required. This configuration significantly increases an overall height of the sliding roof.

It is the object of the invention to provide a more cost-effective spoiler roof with an improved guide system, and which is further distinguished by a small overall height.

### SUMMARY OF THE INVENTION

Compared with most known spoiler roofs, a sliding roof according to the invention has only one central rear guide rail rather than two lateral guide rails. This provides an improved visual impression and a more pleasant joint appearance at an outer roof skin. Further, the outer roof skin becomes smoother as a whole, as any guide rail results in a discontinuation of the outer roof skin, which can be visually unappealing.

In contrast to prior systems, the invention makes provision that a roof skin around a guide rail structure is configured in one piece and as a closed skin, i.e. without any slot. This means, in an example where a guide structure is configured as a separate guide rail, that the roof skin forming an outer termination area of the roof, continuously extends underneath and along the guide rail. Or, in an example where the guide rail is partially received in a recess in the roof skin, that the roof skin extends continuously underneath the guide rail completely around lower and side surfaces so as to form a completely closed skin underneath the guide rail.

Further, in another example, it is possible that the roof skin itself constitutes a guide structure. In this example, the roof skin is formed with an appropriate shape.

No water drain gutter is provided underneath the stationary roof portion and the guide rail. Thus, the subject invention eliminates the need for a water drain gutter by utilizing a central guide rail configuration. In addition, by omitting the water drain gutter, the overall height is reduced, which saves constructional space in a vertical direction.

A pin is rigidly connected with the cover and protrudes downwardly in a region of the rear end of the cover. The pin projects into the central guide rail at least during opening movement of the sliding roof. This means that no lifting mechanism is necessary on the one hand. Further, the pin, in the closed state, only slightly protrudes downwardly, compared with the prior art lever which was swiveled downward. With this, the overall height in the vertical direction is relatively small.

For optimum stabilization, the cover is guided in two lateral guide rails in the region of a front end of the cover. These guide rails are preferably positioned at an inner edge of the roof opening, and are not visible from outside the motor vehicle. The guide rails lie underneath the roof skin in the closed state.

Although the invention is also applicable to so-called “mount-on” covers, i.e. covers that are situated above the roof skin of the adjoining stationary roof portions when the roof opening is closed, the preferred embodiment of the invention relates to a sliding roof including a cover that in the closed state is seated in the roof opening, i.e. continues without any step into the surrounding stationary roof portions, and is lifted when being moved to the rear.

According to a preferred embodiment, the guide rail is integrated in the outer roof skin or is placed on top of the outer roof skin. The integration in the outer roof skin is made, for instance, in that the roof skin itself is deformed and becomes the guide rail by giving the roof skin the shape of an inversed T-groove, for example. Another possibility of integrating the guide rail in the roof skin is to provide the roof skin with a gutter-shaped recess and to embed the guide rail configured as a separate part in this recess. With this embodiment no additional fastening means are necessary for attaching the guide rail in the roof skin.

The stationary roof portion may be made from sheet metal or may be a plastic composite part. Further, a mount-on guide rail includes, for instance, a separate rail that is fixed from outside to the outer roof skin by threaded fasteners or by gluing, for example.

The invention is further distinguished in that the guide rail is configured without any external seal closing the guide rail to the outside. In the prior art, the guide rails always were provided with two seals that were pressed against each other, and which included levers running between the seals, which forced the seals apart. This is cost-intensive and results in enhanced friction. The invention now provides a guide rail that does not require any seal acting to the outside.

These and other features of the present invention can be best understood from the following specification and drawings, the following of which is a brief description.

### BRIEF DESCRIPTION OF THE DRAWINGS

FIG. 1 is a perspective view from a sliding roof incorporating the invention, with a roof opening being closed.

FIG. 2 is a sectional view along line II-II in FIG. 1 through the sliding roof, with the cover being in a raised position.

FIG. 3 is a sectional view along line II-II in FIG. 1 with the cover shifted rearwardly.

FIG. 4 is a cross-sectional view of one example of a central guide rail.

FIG. 5 is a cross-sectional view of another example of a central guide rail.

FIG. 6 is a cross-sectional view of another example of a central guide rail.

### DETAILED DESCRIPTION OF THE PREFERRED EMBODIMENT

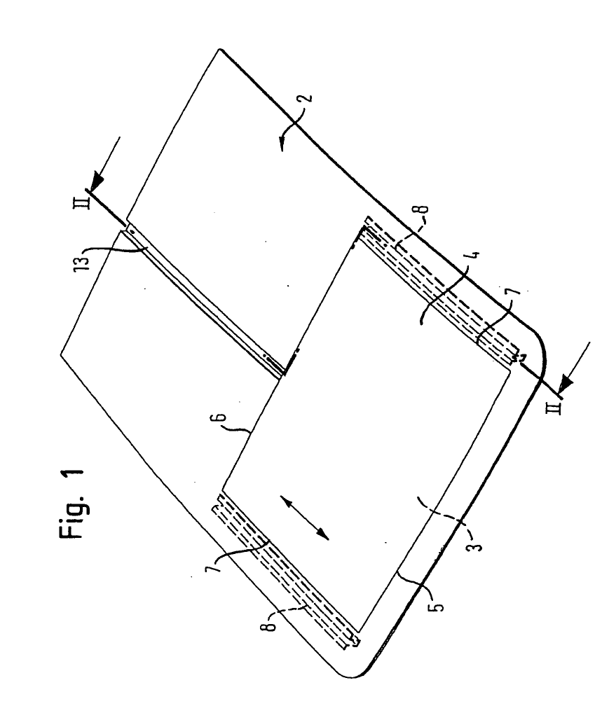

FIG. 1 illustrates a sliding roof for use in a motor vehicle, and which is configured as a module that is fastened on a module edge to a roof frame (not illustrated) with glue. The sliding roof has a stationary roof portion 2 that is made of sheet metal or preferably of composite material, for example. The stationary roof portion 2 has a roof opening 3 that can be closed or exposed by a cover 4. Cover 4 is shiftable in a longitudinal direction of the motor vehicle and is preferably motor-driven. The cover 4 has a front end 5 and a rear end 6 with respect to the longitudinal direction of the motor vehicle.

When closed, the cover 4 is seated in the roof opening 3 and extends with an outer skin of the motor vehicle so as to be flush with adjoining roof skin of the stationary roof portion 2. In other words, the cover 4 does not protrude upwardly with respect to the stationary roof portion 2, as seen from a side view.

The cover 4 is coupled with the stationary roof portion 2 through a guide system including three (3) guide rails. These three guide rails include two guide rails 8 located at lateral edges of the cover 4, and a central guide rail 13 on the stationary roof portion 2.

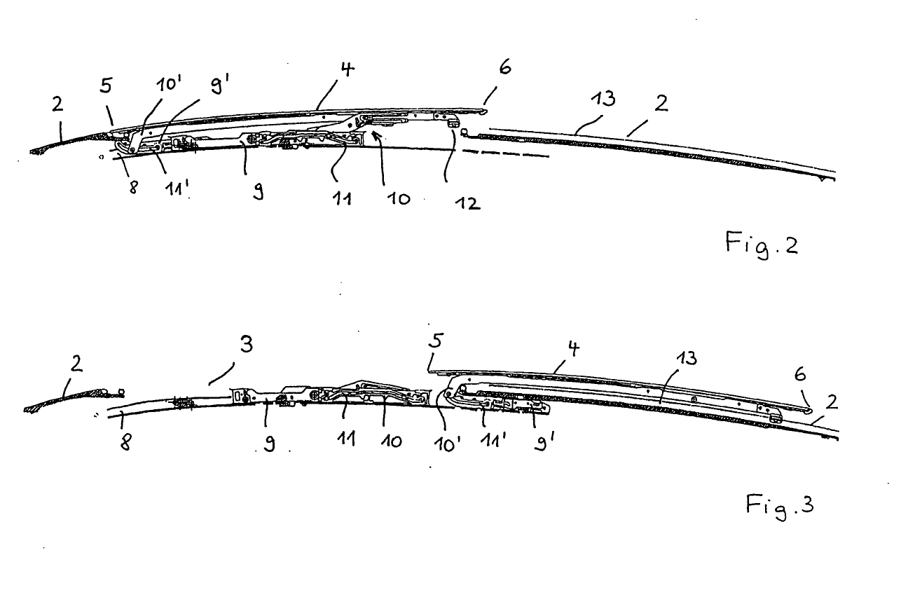

The front end 5 of the cover 4 is guided along side edges 7 in the two guide rails 8 disposed at lateral sides of the cover 4 and arranged on an inner edge of the roof opening 3. Running in the two guide rails 8 are motor-powered gliding pieces 9, 9′ that are coupled with the cover 4 through a guiding mechanism 10, 10′ in the form of several levers, which in part cooperate with slotted guides 11, 11′ (see FIGS. 2 and 3).

A pin, in the form of a T-shaped gliding piece 12, is rigidly fastened to the cover 4. The pin projects from an underside region of the rear end 6 of the cover 4. The pin is not received in a guide when the cover 4 is in a closed state. The T-shaped gliding piece 12 is positioned in a middle area of the cover 4 and cooperates with an external guide structure disposed in the stationary roof portion 2. This external guide structure comprises the central guide rail 13 accommodated in the stationary roof portion 2. This central guide rail 13 is visible from outside the motor vehicle and is open towards a top area, i.e. the central guide rail 13 is not provided with seals that are compressible in lateral directions.

For venting a vehicle interior space, the cover 4 can be lifted at an area near the rear end 6, as is shown in FIG. 2. For this, motor-powered gliding pieces 9 are moved and the corresponding guiding mechanisms 10 ensure the raising or tilting of the cover 4. The cover 4 can also be shifted from this position rearwardly, and over the stationary roof portion 2 in order to completely open the sliding roof and expose the roof opening 3. In so doing, the T-shaped gliding piece 12 penetrates the central guide rail 13 as soon as the cover 4 is shifted rearwardly.

The cover 4 is then disengaged from a part of the guiding mechanism 10 for which a rear end position is reached (see FIG. 3). In this retracted position, the cover 4 is supported in the region of the rear end 6 by the gliding piece 12 in the central guide rail 13. In the region of the front end 5, the guide mechanism 10′, which is still firmly coupled with the cover 4, is mounted in the two lateral guide rails 8 through the slotted guide 11′ via associated gliding pieces 9′.

When the roof opening 3 is in the closed state, the two guide rails 8 cannot be seen from outside the motor vehicle. The two guide rails 8 lie underneath the roof skin and are protected through the roof skin against environmental influences. Water drain gutters are arranged on the two guide rails 8 for piping inflowing water to discharge channels.

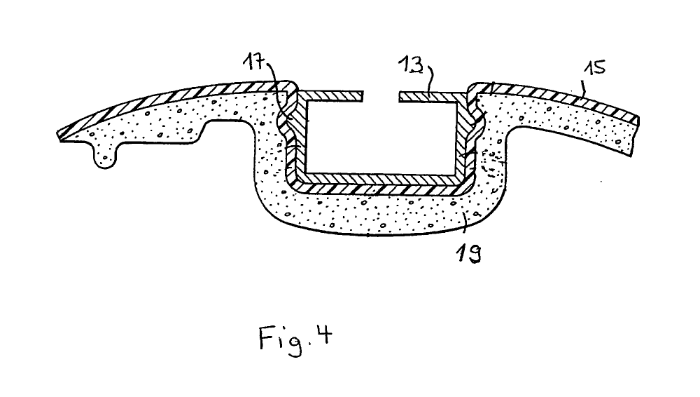

In the embodiment according to FIG. 4, the guide rail 13, which is made from metal or plastics, is integrated in a roof skin 15. The roof skin 15 is one-piece and preferably made of a plastic material that is completely formed around the guide rail 13 along a lower surface and outer wall side surfaces. The roof skin 15 receives the central guide rail 13 with an interlocking fit. For this, protrusions 17 are formed on outer walls of the central guide rail 13, which are received in corresponding recesses in the roof skin 15. The roof skin 15 becomes a composite part by being provided with an injected or foamed backing. There is no need to provide a water drain gutter, since the roof skin 15 is fully closed under and beside the central guide rail 13 and forms a closed skin at this region.

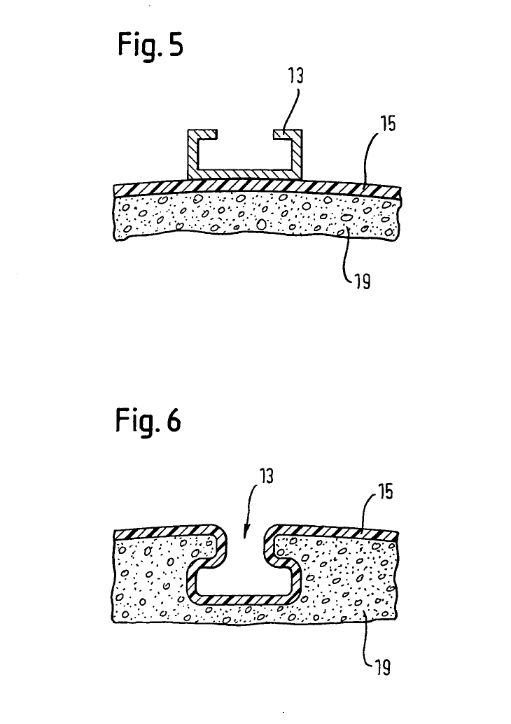

Alternatively, the central guide rail 13 could also be placed on top of the roof skin 15, as is shown in FIG. 5. Here too, the roof skin 15 is formed as one-piece and is made from a plastic material that is provided with a foamed backing. The roof skin 15 continuously extends underneath the central guide rail 13 to form a closed skin as explained with respect to the previously mentioned embodiment, so that the provision of a water drain gutter is not required. In this embodiment, too, the appropriate plastic foam layer is referenced by reference numeral 19.

In the embodiment according to FIG. 6, a guide structure is constituted by the plastically deformed roof skin 15 itself, which is given the form of the central guide rail 13. The roof skin 15 is in one piece and forms a closed skin, also in the region of the guide structure, so that again a water drain gutter is unnecessary.

Although a preferred embodiment of this invention has been disclosed, a worker of ordinary skill in this art would recognize that certain modifications would come within the scope of this invention. For that reason, the following claims should be studied to determine the true scope and content of this invention.

1. A sliding roof for a motor vehicle, comprising
a cover for selectively opening and closing a roof opening, wherein the cover is shifted over a stationary roof portion to open the roof opening;
a guide system for the cover;
a guide rail structure that is centrally provided on the stationary roof portion as seen in a longitudinal vehicle direction, the cover being guided in a region of a rear end of the cover, wherein the rear end is movable along the guide rail structure at least during opening movement of the cover; and
a roof skin formed as one piece that cooperates with the stationary roof portion to provide a sealed skin in a region of the guide rail structure.

2. The sliding roof according to claim 1, wherein the cover is guided in two lateral guide rails in a region of a front end of the cover.

3. The sliding roof according to claim 2, wherein the two lateral guide rails are arranged at edges of the roof opening.

4. The sliding roof according to claim 2, wherein the two lateral guide rails lie underneath the roof skin such that the two lateral guide rails are not visible from outside the motor vehicle, when the sliding roof is closed.

5. The sliding roof according to claim 1, wherein the cover is seated in the roof opening when the sliding roof is closed, and wherein the cover is liftable for venting or shifting to an open position.

6. The sliding roof according to claim 1, including a pin rigidly connected with the cover and projecting downwardly in the region of the rear end of the cover, wherein the pin projects into the guide rail structure at least during opening of the sliding roof and is received in the guide rail structure with an interlocking fit.

7. The sliding roof according to claim 6, wherein the pin is a gliding piece that penetrates the guide rail structure and couples the guide rail structure with the cover when shifting the cover rearwardly.

8. The sliding roof according to claim 1, wherein the guide rail structure is a central guide rail configured as a separate part that is supported by the roof skin.

9. The sliding roof according to claim 8, wherein the roof skin extends underneath the central guide rail.

10. The sliding roof according to claim 8, wherein the central guide rail is integrally formed with the roof skin.

11. The sliding roof according to claim 8, wherein the central guide rail has an upper surface and a lower surface with the roof skin completely surrounding the lower surface of the central guide rail.

12. The sliding roof according to claim 11, wherein the lower surface extends along a pair of side walls and a bottom portion interconnecting the pair of side walls.

13. The sliding roof according to claim 1, wherein the roof skin is shaped to form the guide rail structure.

14. The sliding roof according to claim 13, wherein the roof skin includes a longitudinally extending recess that forms the guide rail structure.

15. The sliding roof according to claim 1, wherein the stationary roof portion does not include a water drain gutter in a region of the guide rail structure.

16. The sliding roof according to claim 1, wherein the guide rail structure does not include any outer seals.

17. The sliding roof according to claim 1, wherein the guide rail structure comprises a single central guide rail fixed to the roof skin.

18. The sliding roof according to claim 17, wherein the roof skin is formed as one piece around the single central guide rail such that a continuous, unbroken roof skin surface extends from one lateral side of the single central guide rail to an opposite lateral side of the single central guide rail to provide a completely sealed interface between the roof skin and the single central guide rail without any other sealing components.
